(19) United States
(12) Patent Application Publication
(10) Pub. No.: US 2026/0195315 A1
(43) Pub. Date: Jul. 9, 2026

(54) NETWORK SWITCH CIRCUITRY WITH IN-MEMORY DATABASE HAVING SEMI-LOCKLESS ATOMIC OPERATIONS

(71) Applicant: Hewlett Packard Enterprise Development LP, Spring, TX (US)

(72) Inventors: Diego A Dompe Gamboa, Escazu (CR); David Jose Ramirez Perez, Sr., Desamparados (CR); Marco Ney Rojas Jimenez, Heredia (CR)

(21) Appl. No.: 19/014,783

(22) Filed: Jan. 9, 2025

(51) Int. Cl. G06F 16/23; G06F 16/27

(52) U.S. Cl. CPC G06F 16/2343; G06F 16/27

(57) ABSTRACT

This disclosure is directed to a network switch with decentralized processing threads for accessing a shared database. The network switch may include database may include tables storing data entries, and processing circuitry that may define independent processing threads. Each processing thread may implement a packet processing pipeline including a shared database logic of the database. The packet processing pipelines may access data entries by referencing the database logic to perform network operations. Each packet processing pipeline may use semi-lockless atomic operations with temporary spin-locks to access target data entries without locking access of other packet processing pipelines to other data entries. As such, the packet processing pipelines may access an increased number of data entries of the database simultaneously. Moreover, the processing circuitry may allocate portions of the database to different packet processing pipelines to reduce contention and waiting times when accessing the database using the semi-lockless atomic operations.

### BACKGROUND

Processing circuitry may store and update data on memory/storage devices. Performing an increasing number of processing operations in parallel may demand a higher volume of data storage and/or memory access which may reduce an overall processing rate of the processing circuitry.

### BRIEF DESCRIPTION OF THE DRAWINGS

Features, aspects, and advantages of the present disclosure will become better understood when the following detailed description is read with reference to the accompanying drawings in which like characters represent like parts throughout the drawings, wherein:

FIG. 1 is a block diagram of a chassis including a network switch with decentralized processing threads implementing packet processing pipelines for accessing a shared database, in accordance with an aspect of present disclosure;

FIG. 2 is a functional block diagram of a portion of the network switch of FIG. 1 illustrating a mapping of the database in multiple packet processing pipelines, in accordance with an aspect of the present disclosure;

FIG. 3 is a functional block diagram of a portion of the network switch of FIG. 1 illustrating multiple packet processing pipelines accessing the database during at least partially overlapping time periods, in accordance with an aspect of the present disclosure;

FIG. 4 is a block diagram of the network switch of FIG. 1 with an internal and/or external memory device including the database, in accordance with an aspect of the present disclosure;

FIG. 5 is a process flow diagram illustrating a process of accessing the database of FIG. 1 by multiple packet processing pipelines during at least partially overlapping time periods, in accordance with an aspect of the present disclosure; and

FIG. 6 is a process flow diagram illustrating a process of accessing a target data entry of the database of FIG. 1 by multiple packet processing pipelines using semi-lockless atomic operations with temporary spin-locks, in accordance with an aspect of the present disclosure.

### DETAILED DESCRIPTION

Processing circuitry of a network switch may perform network operations such as storing and updating data values on a database of the network switch. For example, the processing circuitry may access the database to store and/or update data values such as analytics, traffic statistics, or packet flow telemetry of input data being routed, transferred, and/or encrypted by the network switch. The processing circuitry may demand access to the database based on an amount of input data being received by the network switch and/or a number of network operations being performed by the processing circuitry. Moreover, an amount of input data of the network switch and/or a number of the network operations of the processing circuitry may increase. As such, the processing circuitry may demand a higher number of accesses to the database at each time and/or over a time period based on the increased number of input data and/or network operations. With the foregoing in mind, an overall throughput of the processing circuitry and/or the network switch may improve by increasing a number of processing circuitry accesses to the database during overlapping time periods and/or simultaneously.

The processing circuitry may include processing resources such as a number of processing cores, among other possibilities. Increasing a number of processing cores and/or increasing an amount of processing resources of the processing circuitry may improve an overall processing rate of the processing circuitry and/or the network switch. However, contention and waiting times for accessing the database may not improve linearly with the improvement in the overall processing rate of the processing circuitry and/or the network switch.

This disclosure is directed to allocating dedicated portions of the processing circuitry to independently access the database. For example, the processing circuitry may define multiple independent processing threads, where each processing thread may include a portion of the processing resources of the processing circuitry. Each processing thread may implement a packet processing pipeline including a shared database logic of the database. The database logic may define a structure of the database. The packet processing pipelines may independently access data entries of the database by referencing the database logic to perform the network operations. Each packet processing pipeline may use semi-lockless atomic operations with temporary spin-locks to access target data entries without locking access of other packet processing pipelines to other data entries. As such, the packet processing pipelines may access an increased number of data entries of the database simultaneously or during at least partially overlapping time periods. Moreover, the processing circuitry may allocate portions of the database to different packet processing pipelines to reduce contention and waiting times when accessing the database using the semi-lockless atomic operations.

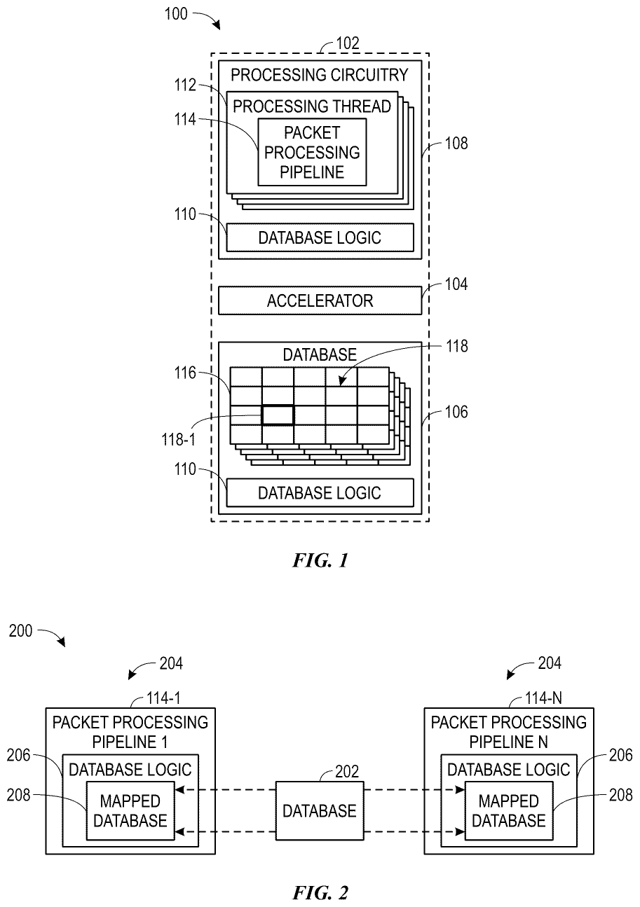

FIG. 1 is a block diagram of a network switch 100 disposed on a network switch chassis 102, in accordance with an aspect of present disclosure. The network switch 100 may include an application-specific integrated circuit (ASIC) 104, a database 106 (e.g., an in-memory database), and processing circuitry 108. The network switch 100 may perform network operations based on input data of the network switch 100 and access and/or update the database 106 based on performing the network operations, as will be appreciated. Although the network switch chassis 102 is shown to include the network switch 100, it should be appreciated that one or more components of the network switch 100 may be disposed outside of the network switch chassis 102. Moreover, the network switch 100 may include additional components not shown for simplicity or may not include one or more of the depicted components. For example, the database 106 may include multiple databases 106 disposed inside and/or outside of the network switch chassis 102.

The network operations may include routing, transferring, and/or encrypting received input data of the network switch 100 and/or the determining and routing, transferring, and/or encrypting data values associated with the received input data, among other things. The data values may include analytics, traffic statistics, or packet flow telemetry of received input data, among other possibilities. In specific cases, the data values may include at least a portion of the input data. The ASIC 104 may receive the input data and may perform at least a portion of the network operations. In some implementations, the ASIC 104 may include an accelerator, at least a portion of the processing circuitry 108, and/or other things, among other possibilities. Moreover, the processing circuitry 108 may perform a remaining portion of the network operations. For example, the processing circuitry 108 may offload a portion of the network operations associated with the input data to the ASIC 104. The ASIC 104 and/or the processing circuitry 108 may generate the data values based on the input data.

The database 106 may include (e.g., store) a number of tables 116 with data entries 118 (e.g., key-value data entries) for storing data values associated with input data. Each table 116 may have any viable number of data entries 118 equal to or different from a number of data entries 118 of other tables 116 of the database 106. The database 106 may provide (e.g., share) a database logic 110 including a set of (e.g., a library of) instructions for defining packet processing pipelines 114 (e.g., software-defined packet processing pipelines 114) to the processing circuitry 108. The database logic 110 may be indicative of a structure or definition of and/or values stored with the tables 116 and/or the data entries 118 of the database 106. For example, the database logic 110 may be indicative of a tabular structure and/or key-value addresses of the tables 116 and/or the data entries 118.

The processing circuitry 108 may access (e.g., insert, update, and/or delete) at least a portion of the tables 116 and/or the data entries 118 of the database 106 by defining the packet processing pipelines 114 on allocated processing threads 112. The processing circuitry 108 may request, retrieve, and/or determine the database logic 110 from the database 106. For example, the database 106 may output the database logic 110 to the processing circuitry 108. Alternatively or additionally, the processing circuitry 108 may generate the database logic 110 by determining (e.g., receiving, retrieving) an indication of a structure of the tables 116 and/or data entries 118 stored in the database 106.

The processing circuitry 108 may include one or more processing cores implementing a number of processing threads 112. The processing circuitry 108 may define each processing thread 112 by allocating a portion (e.g., dedicated processing resources) of one or more of the processing cores. The processing circuitry 108 may share the database logic 110 of the database 106 with each of the processing threads 112. Moreover, the processing circuitry 108 may define the packet processing pipelines 114 on the processing threads 112. As such, the processing threads 112 may each include (e.g., independently include) a packet processing pipeline 114 using the database logic 110.

The packet processing pipelines 114 may access at least a portion of the database 106 based on a definition or description of a shared memory area of the database 106 including the tables 116 and/or data entries 118 by referencing the shared database logic 110. For example, each packet processing pipeline 114 may access at least a portion of the database 106 to insert, update, and/or delete the data entries 118 of the tables 116 of the database 106 based on the data values. In some cases, the database 106 may include one or more portions that are not defined by the shared database logic 110 or are not accessible by the packet processing pipelines 114. Such portions of the database 106 may be accessible by other portions of the processing circuitry 108 and/or the ASIC 104, among other possibilities.

The packet processing pipelines 114 may access target data entries 118 by performing semi-lockless atomic operations by implementing temporary spin-locks on the target data entries 118, as will be appreciated. The database 106 may store key-value data entries with predetermined sizes. As such, the packet processing pipelines 114 may access target data entries 118 with reduced (or without) serialization/deserialization based on generating data entry access requests with predetermined key and/or value sizes. For example, the packet processing pipelines 114 may access target values (e.g., counter values, etc.) stored in target data entries 118 with reduced processing (e.g., overhead) by omitting serialization and/or deserialization of the data entry access requests and/or the received target values. Moreover, the packet processing pipelines 114 may perform operations such as masking and unmasking of the data entry access requests and/or the target values with reduced processing and/or increased rate based on the predetermined key and/or value sizes.

Alternatively or additionally, the database 106 may store index values with each data entry 118. As such, an increased number of the packet processing pipelines 114 may access target data entries 118 in parallel or during at least partially overlapping time periods by targeting the indexes (e.g., keys) of the target data entries 118. Moreover, the packet processing pipelines 114 may lock each of the target data entries 118 being accessed using a semi-lockless atomic operation by indicating a temporary spin-lock on the respective indexes and/or keys of the target data entries 118. For example, the packet processing pipelines 114 may lock individual target data entries 118 using the indexes and/or the keys having predetermined sizes as opposed to locking access to multiple or the entirety of the target data entries 118, as will be appreciated.

As mentioned above, the packet processing pipelines 114 may access target data entries 118 by performing semi-lockless atomic operations by implementing temporary spin-locks on the target data entries 118. For example, a packet processing pipeline 114 may temporarily lock (e.g., prevent) access of other packet processing pipelines 114 to (e.g., only to) a target data entry 118 during a semi-lockless atomic operation using a temporary spin-lock. The processing circuitry 108 may provide and/or maintain an indication of the temporary spin-lock on the target data entry 118 to the other packet processing pipelines 114. As such, the packet processing pipeline 114 may locate and access (e.g., insert, update, and/or delete) the target data entry 118 without interruption from other packet processing pipelines 114.

Moreover, the packet processing pipeline 114 may allow the other packet processing pipelines 114 to perform respective semi-lockless atomic operations on other data entries 118 during the semi-lockless atomic operation. For example, each packet processing pipeline 114 may not lock access to other data entries 118 of the database 106 other than a target data entry 118 (e.g., as opposed to locking access to multiple or the entirety of the target data entries 118) based on using a temporary spin-lock to access the target data entry 118. Accordingly, each of two or more packet processing pipelines 114 targeting a data entry 118 at overlapping time periods may take turns for accessing the target data entry 118 using the temporary spin-locks.

With the foregoing in mind, multiple packet processing pipelines 114 may access multiple data entries 118 simultaneously, nearly simultaneously, and/or during at least partially overlapping time periods by performing semi-lockless atomic operations with temporary spin-locks on target data entries 118. For example, the processing circuitry 108 may access an increased number of data entries 118 of the database 106 over a time period based on each packet processing pipeline 114 not locking data entries 118 other than a respective target data entry 118 at each time. Accordingly, the network switches 10 may have an increased database throughput and/or have a reduced database contention rate compared to other network switches by implementing multiple independent processing threads 112 sharing the database logic 110 of the database 106, defining the packet processing pipelines 114 by each processing thread 112 using the shared database logic 110, and incorporating the semi-lockless atomic operations and the temporary spin-locks with the packet processing pipelines 114.

By way of example, a first packet processing pipeline 114 may perform a first semi-lockless atomic operation on a first data entry 118-1 by temporarily locking access of other packet processing pipelines 114 to the first data entry 118-1. The first packet processing pipeline 114 may access the first data entry 118-1 by temporarily locking the first data entry 118-1 during the first semi-lockless atomic operation by a first temporary spin-lock. A number of second packet processing pipelines 114 may attempt accessing the first data entry 118-1 during the first semi-lockless atomic operation. The second packet processing pipelines 114 may wait for completion of the first semi-lockless atomic operation when the first data entry 118-1 is locked by the first temporary spin-lock.

The second packet processing pipelines 114 may repeatedly check a lock status of the first data entry 118-1 in response to the first data entry 118-1 being locked. For example, the second packet processing pipelines 114 may continuously poll the lock status of the first data entry 118-1 with or without a delay after each determination of the first data entry 118-1 being locked. In some cases, the processing circuitry 108 may provide and/or maintain an indication of the first temporary spin-lock on the first data entry 118-1 by a coherency protocol (e.g., a cache coherency protocol). The processing circuitry 108 may snoop inside the processing threads 112 and/or the database 106 using the database logic 110 via the coherency protocol, such as a Compute Express Link (CXL) protocol. As such, the processing threads 112 may each have access to and/or may receive the lock statuses of the data entries 118 of the database 106 including the first data entry 118-1 via the coherency protocol of the processing circuitry 108. Accordingly, the second packet processing pipelines 114 may repeatedly check the lock status of the first data entry 118-1 to determine whether the first temporary spin-lock is removed. Additionally or alternatively, in some implementations, the second packet processing pipelines 114 may use a timer to estimate lapsation of the lock and/or wait to receive a notification from the database 106 and/or other processing threads indicating that the lock has been removed or has elapsed.

The second packet processing pipelines 114 may take turns accessing the first data entry 118-1 when two or more second packet processing pipelines 114 are waiting to access the first data entry 118-1. The second packet processing pipelines 114 may access the first data entry 118-1 by taking turns (e.g., one by one in an order) after the first temporary spin-lock is removed. That is, at each time, one of the second packet processing pipelines 114 targeting the first data entry 118-1 may access the target data entry 118 using the temporary spin-locks. For example, the processing circuitry 108 may track an access attempt order of the second packet processing pipelines 114 by the coherency protocol and/or by incrementing a software or hardware (e.g., register) implemented counter, among other possibilities. As such, the second packet processing pipelines 114 may access the first data entry 118-1 in the order of the access attempts and based on the coherency protocol and/or the counter, among other possibilities.

With the foregoing in mind, the processing circuitry 108 may allocate different portions of the tables 116 and/or the data entries 118 to different packet processing pipelines 114. For example, the processing circuitry 108 may distribute (e.g., allocate) the portions of the database 106 between the packet processing pipelines 114 to reduce an occurrence (e.g., a probability) of concurrently targeting a data entry 118 by two or more packet processing pipelines 114 at overlapping time periods. The processing circuitry 108 may allocate the tables 116, one or more portions of one or more of the tables 116, and/or any viable distribution of the data entries 118 to one or more of the packet processing pipelines 114. As such, the processing circuitry 108 may reduce an occurrence of temporary waiting (e.g., spinning) of one or more of the packet processing pipelines 114 to take turns (e.g., wait, spin) for accessing a target data entry 118 using temporary spin-locks. Accordingly, the processing circuitry 108 may reduce the database contention rate and/or increase the throughput of the database 106 compared to that of other network switches based on allocating different portions of the database 106 to different packet processing pipelines 114.

FIG. 2 is a functional block diagram of a portion of a network switch 200 illustrating a mapping (e.g., instance) of a database 202 in multiple packet processing pipelines 204 (individually referred to as packet processing pipelines 114-1 through 114-N), in accordance with an aspect of the present disclosure. In some implementations, the network switch 200 may be similar to the network switch 100 discussed above. Likewise, the database 202 may be similar to and function similar to the database 106. The packet processing pipelines 204 may be implemented in a processing circuitry, such as the processing circuitry 108. As discussed above, the processing circuitry of the network switch 200 may define a number of (e.g., 1, 2, 3, 4, N) packet processing pipelines 114.

For example, the processing circuitry may define each of the packet processing pipelines 114-1 through 114-N by sharing (e.g., incorporating) a database logic 1106 of the database 202 with each of the packet processing pipelines 114-1 through 114-N. The database logic 1106 may be similar to and function similar to the database logic 110. The database logic 1106 may be indicative of (e.g., including) a set of software instructions for defining packet processing pipelines 114-1 through 114-N by including a structure or definition of and/or values stored with the tables and/or the data entries of the database 202. The tables and/or the data entries of the database 202 may be similar to and function similar to the tables 116 and/or the data entries 118. Although packet processing pipelines 114-1 and packet processing pipelines 114-N are shown in FIG. 2, it should be appreciated that the network switch 100 may include any viable number of packet processing pipelines 114-1 through 114-N.

One or more of the packet processing pipelines 114-1 through 114-N may perform network operations to route, transfer, and/or encrypt the input data, and/or determine and/or store the data values associated with the input data. The data values may include analytics-based traffic statistics or packet flow telemetry, among other possibilities. Moreover, each of the packet processing pipelines 114-1 through 114-N may receive and/or determine a mapped database 208 based on the database logic 1106. For example, the database logic 1106 may include the mapped database 208.

The mapped database 208 may be indicative of the structure or the definition of and/or the values stored with the tables and/or the data entries of the database 202. For example, the mapped database 208 may include an instance of the database 202. The packet processing pipelines 114-1 through 114-N may each use the mapped database 208 incorporated therewith to access target tables and/or entries of the database 202 independently. Accordingly, each of the packet processing pipelines 114-1 through 114-N may independently attempt accessing the database 202 using semi-lockless atomic operations using the mapped database 208 to update (e.g., access) the database 202 based on the determined data values.

The database 202 and the processing circuitry including the packet processing pipelines 114-1 through 114-N may coordinate coherency of the mapped database 208 between the packet processing pipelines 114-1 through 114-N. The processing circuitry may execute instructions (e.g., coherency protocol instructions) to update the database logic 1106 and/or the mapped database 208, for example, by snooping inside the database 202. The updates may be indicative of data entries being targeted by each of the packet processing pipelines 114-1 through 114-N using semi-lockless atomic operations and/or the temporary spin-locks. Moreover, each of the packet processing pipelines 114-1 through 114-N incorporating the database logic 1106 and/or the mapped database 208 may receive the updates of the database logic 1106 reflected in the mapped database 208 incorporated therewith. For example, the database 202 may provide (e.g., output) the updates to the database logic 1106 and/or the mapped database 208 to the packet processing pipelines 114-1 through 114-N.

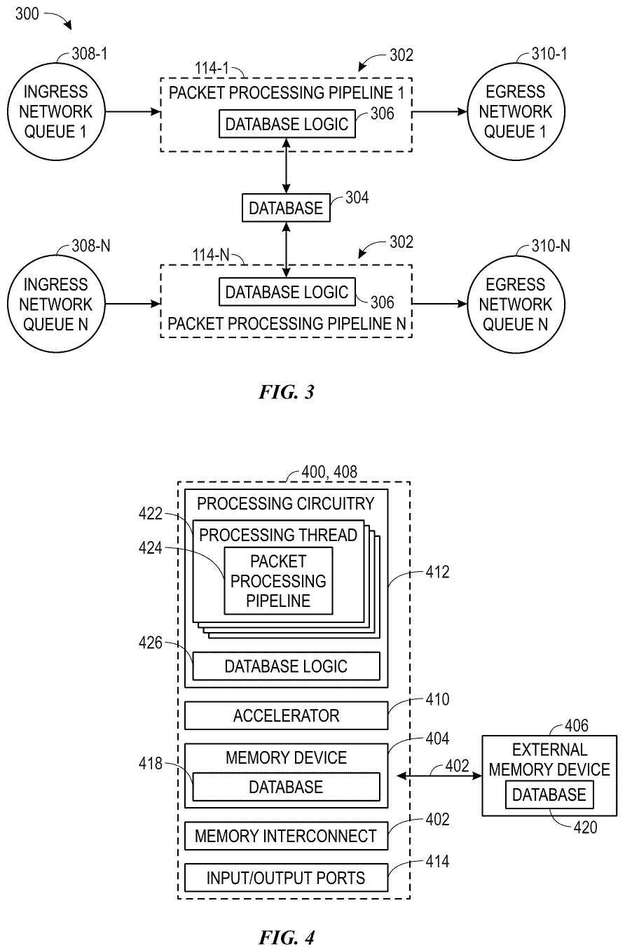

FIG. 3 is a functional block diagram illustrating multiple packet processing pipelines 302 (individually referred to as packet processing pipelines 114-1 through 114-N) of a network switch 300 accessing a database 304 during at least partially overlapping time periods, in accordance with an aspect of the present disclosure. In some implementations, the network switch 300 may be similar to the network switch 100 and/or 200 discussed above. Likewise, the database 304 may be similar to and function similar to the database 106 and/or 202. Moreover, the packet processing pipelines 302 may be similar to and function similar to the packet processing pipelines 114 and/or 204.

The packet processing pipelines 302 may be implemented in a processing circuitry, such as the processing circuitry 108. As mentioned above, the database 304 may provide (e.g., share) a database logic 306 with the depicted packet processing pipelines 114-1 and 114-N. The database logic 306 may be similar to and function similar to the database logic 110 and/or 206. Moreover, each of the packet processing pipelines 114-1 and 114-N may incorporate the database logic 306 of the database 304. Although packet processing pipelines 114-1 and packet processing pipelines 114-N are shown in FIG. 3, it should be appreciated that the network switch 300 may include any viable number of (e.g., 1, 2, 3, N) packet processing pipelines 114-1 through 114-N. That is, each of the packet processing pipelines 114-1 through 114-N may incorporate the database logic 306 of the database 304.

A packet processing pipeline 114 may perform a respective network operation at each time and determine data values based on received input data. The data values may include analytics-based traffic statistics or packet flow telemetry associated with the received input data and/or the respective network operation, among other possibilities. As discussed above, the packet processing pipelines 114-1 through 114-N may independently access the database 304 using semi-lockless atomic operations and/or the temporary spin-locks to update (e.g., access) the database 304 based on the data values.

By way of example, the processing circuitry may generate a number of ingress network queues 308 for performing the network operations by the packet processing pipelines 114. An ingress network queue 308 may include input data and/or instructions associated with a respective network operation. The processing circuitry may distribute the ingress network queues 308 between the packet processing pipelines 114. For example, each packet processing pipelines 114-1 through 114-N may carry out one network operation associated with an ingress network queue 308 at each time.

Each packet processing pipelines 114 may generate an egress network queue 310 and/or data values by processing the ingress network queue 308 using the database logic 306. The packet processing pipelines 114 may output the egress network queue 310 to any viable receiving device. For example, each packet processing pipeline 114-1 through 114-N may route, transfer, and/or encrypt the input data of a respective ingress network queue 308 to a receiving device, among other possibilities. Moreover, one or more of the packet processing pipelines 114-1 through 114-N may update (e.g., access, store) the database 106 with data values determined based on processing the respective network operation using the database logic 306. That is, each of the one or more of the packet processing pipelines 114-1 through 114-N may access (e.g., insert, update, and/or delete) at least a portion of the tables and/or the data entries of the database 202 based on the respective data values.

In FIG. 3, an ingress network queue 308-1 (e.g., a first ingress network queue 1) may include a first portion of the input data and an ingress network queue 308-N (e.g., an N^{th} ingress network queue N) may include an N^{th} portion of the input data. For example, the processing circuitry (e.g., the processing circuitry 108) may include instructions indicative of a first network operation with the ingress network queue 308-1 and instructions indicative of an N^{th} network operation with the ingress network queue 308-N. Moreover, the processing circuitry may provide the ingress network queue 308-1 to the packet processing pipeline 114-1 and provide the ingress network queue 308-N to the packet processing pipeline 114-N.

The packet processing pipeline 114-1 may receive the ingress network queue 308-1. The packet processing pipeline 114-1 may perform the first network operation based on the ingress network queue 308-1. The packet processing pipeline 114-1 may generate an egress network queue 310-1 (e.g., a first egress network queue 1) including the first portion of the input data, as adjusted and/or altered by performing the first network operation. For example, the packet processing pipeline 114-1 may route, transfer, and/or encrypt the first portion of the input data to adjust and/or alter the first portion of the input data, among other possibilities. The packet processing pipeline 114-1 may output the egress network queue 310-1 to any viable receiving device. In some cases, the packet processing pipeline 114-1 may include first data values associated with the first portion of the input data with the egress network queue 310-1.

The packet processing pipeline 114-1 may generate first data values based on performing the first network operation on the first portion of the input data. The packet processing pipelines 114-1 may generate the first data values by determining analytics-based traffic statistics or packet flow telemetry of the first portion of the input data and/or the first network operation, among other possibilities. The packet processing pipeline 114-1 may update a database 304 using the first data values by executing one or more semi-lockless atomic operations with the temporary spin-locks. The database 304 may be similar to and function similar to the databases 106 and/or 202. For example, the packet processing pipelines 114-1 may store the first data values in the database 304 by accessing (e.g., inserting, updating, and/or deleting) at least a portion of tables and/or the data entries of the database 304. The tables and/or the data entries of the database 304 may be similar to and function similar to the tables 116 and/or the data entries 118.

Before, after, or during at least partially overlapping time periods for performing the first network operations discussed above by the packet processing pipeline 114-1, the packet processing pipeline 114-N may receive the ingress network queue 308-N. The packet processing pipeline 114-N may perform the N^{th} network operation based on the ingress network queue 308-N. The packet processing pipeline 114-N may generate an egress network queue 310-N (e.g., an N^{th} egress network queue 1) including the N^{th} portion of the input data, as adjusted and/or altered by performing the N^{th} network operation. For example, the packet processing pipeline 114-N may route, transfer, and/or encrypt the N^{th} portion of the input data to adjust the N^{th} portion of the input data, among other possibilities. The packet processing pipeline 114-N may output the egress network queue 310-N to any viable receiving device. In some cases, the packet processing pipeline 114-N may include N^{th} data values associated with the N^{th} portion of the input data with the egress network queue 310-N.

The packet processing pipeline 114-N may generate the N^{th} data values based on performing the N^{th} network operation on the N^{th} portion of the input data. The packet processing pipelines 114-N may generate the N^{th} data values by determining analytics-based traffic statistics or packet flow telemetry of the N^{th} portion of the input data and/or the N^{th} network operation, among other possibilities. The packet processing pipeline 114-N may update the database 304 using the N^{th} data values by executing one or more semi-lockless atomic operations with the temporary spin-locks. For example, the packet processing pipelines 114-N may store the N^{th} data values in the database 304 by accessing (e.g., inserting, updating, and/or deleting) at least a portion of the tables and/or the data entries of the database 304.

The network switch 300 may include any viable number of (e.g., 1, 2, 3, N) packet processing pipelines 114 accessing the database 304 by performing semi-lockless atomic operations with the temporary spin-locks. That is, any number of packet processing pipelines 114 may perform at least partially or substantially similar operations during at least partially overlapping time periods (e.g., at least partially simultaneously). Accordingly, the processing circuitry and/or the packet processing pipelines 114 may access an increased number of data entries 118 of the database 304 over a time period based on each packet processing pipeline 114-1 through 114-N not locking data entries 118 other than a respective target data entry 118 at each time. Moreover, the network switch 300 may have an increased database throughput and/or have a reduced database contention rate compared to other network switches by defining multiple packet processing pipelines 114 using the shared database logic 306 and incorporating the semi-lockless atomic operations and the temporary spin-locks with the packet processing pipelines 114.

With the foregoing in mind, the processing circuitry may allocate different portions of the tables and/or the data entries to each of the packet processing pipelines 114-1 through 114-N. For example, the processing circuitry may distribute (e.g., allocate) the portions of the database 304 between the packet processing pipelines 114-1 through 114-N to reduce an occurrence (e.g., a probability) of concurrently targeting a data entry 118 by two or more packet processing pipelines 114-1 through 114-N at overlapping time periods. As such, the processing circuitry may reduce an occurrence of temporary waiting (e.g., spinning) of one or more of the packet processing pipelines 114 to take turns (e.g., wait, spin) for accessing a target data entry 118 using temporary spin-locks. Accordingly, the processing circuitry may reduce the database contention rate and/or increase the throughput of the database 304 compared to that of other network switches based on allocating different portions of the database 304 to different packet processing pipelines 114.

FIG. 4 is a block diagram of the network switch 400 including a memory interconnect 402, and a memory device 404, in accordance with an aspect of the present disclosure. A network switch chassis 408 may include an ASIC 410, processing circuitry 412, the memory interconnect 402, input/output (I/O) ports 414, and the memory device 404. The processing circuitry 412 of the network switch 400 may be coupled to an external memory device 406 (e.g., a storage device, a disaggregated memory), as will be appreciated. In some implementations, the network switch chassis 408 may be similar to the network switch chassis 102. The ASIC 410 may be similar to and function similar to the ASIC 104. Likewise, the processing circuitry 412 may be similar to and function similar to the processing circuitry 108. It should be appreciated that the network switch 10 may include alternative or additional components and/or may omit one or more of the illustrated components.

The memory device 404 may include a first database 418. The external memory device 406 may be disposed outside of the network switch chassis 408. In some implementations, the external memory device 406 may include a second database 420. For example, the databases 106, 202, and 304 may be similar to and function similar to the first database 418, the second database 420, or both. The processing circuitry 412 may access (e.g., insert, update, and/or delete) at least a portion of tables and/or the data entries of the databases 418 and/or 420 by defining packet processing pipelines 424 on allocated processing threads 422.

The processing circuitry 412 may define each processing thread 112 by allocating a portion (e.g., dedicated processing resources) of the respective processing resources. The tables and/or the data entries of the databases 418 and 420 may be similar to and function similar to the tables 116 and/or the data entries 118. The processing circuitry 412 may request, retrieve, and/or determine a database logic 426 from the databases 418 and/or 420. The database logic 426 may be similar to and function similar to the database logic 110. For example, the databases 418 and/or 420 may output the database logic 426 to the processing circuitry 412. Alternatively or additionally, the processing circuitry 412 may generate the database logic 426 by determining (e.g., receiving, retrieving) an indication of a structure of the tables and/or data entries stored in the databases 418 and/or 420.

The processing circuitry 412 may share the database logic 426 of the databases 418 and/or 420 with each of the processing threads 422. Moreover, the processing circuitry 412 may define the packet processing pipelines 424 on the processing threads 422 based on the database logic 426. As such, the processing threads 422 may each include (e.g., independently include) a packet processing pipeline 424 using the database logic 426. The packet processing pipelines 422 may be similar to and function similar to the packet processing pipelines 114, 204, and/or 302.

The I/O ports 414 may communicate data between the network switch 400 and other devices and components. For example, the ASIC 410 and/or the processing circuitry 412 may receive the input data via the I/O ports 414. The I/O ports 414 may include any number of connectors (e.g., pins) to couple to other devices and components. The memory interconnect 402 may couple the I/O ports 414, the ASIC 410, the processing circuitry 412, the memory device 404 and/or the first database 418, and the external memory device 406 and/or the second database 420, or any combination thereof, among other things. The memory interconnect 402 may communicate the input data and the data values discussed above, among other data, control signals, and/or instructions, between such components.

The memory interconnect 402 may include a physical layer to execute instructions of an interconnect protocol. The physical layer of the memory interconnect 402 may include any viable interconnect scheme (e.g., a Peripheral Component Interconnect Express (PCIe)) to execute instructions of the interconnect protocol (e.g., a Compute Express Link (CXL)). The processing circuitry 412 may execute instructions of the coherency protocol (e.g., a cache coherency protocol) discussed above to snoop inside the databases 418 and/or 420 via the physical layer and/or the interconnect protocol of the memory interconnect 402.

For example, a portion of the instructions of the coherency protocol of the processing circuitry 412 may include instructions of the interconnect protocol. Alternatively or additionally, a portion of the instructions of the coherency protocol of the processing circuitry 412 may correspond and/or translate to instructions of the interconnect protocol. The memory interconnect 402 may include processing circuitry (e.g., dedicated processing circuitry) to correspond and/or translate the instructions of the coherency protocol of the processing circuitry 412 to instructions of the interconnect protocol. For example, the processing circuitry of the memory interconnect 402 may include one or more processors, logic controllers, Direct Memory Access (DMA) Controllers, Application-Specific Integrated Circuits (ASICs), interconnect logic, or any combination thereof, among other possibilities. As such, the processing circuitry 412 may connect (e.g., interface) with the memory device 404 and the external memory device 406 via the memory interconnect 402.

The memory device 404 and the external memory device 406 may each include non-transitory, computer-readable media (e.g., any suitable form of memory or storage) that may store the databases 418 and/or 420, respectively, and/or processor-executable code used by the processing circuitry 412 to perform the presently disclosed techniques. Alternatively or additionally the processing circuitry 412 may include non-transitory, computer-readable media (e.g., any suitable form of memory or storage) to store at least a portion of the processor-executable code, the database logic 426, the processing threads 422, and/or the packet processing pipelines 424, among other things. It should be noted that non-transitory merely indicates that the media is tangible and not a signal.

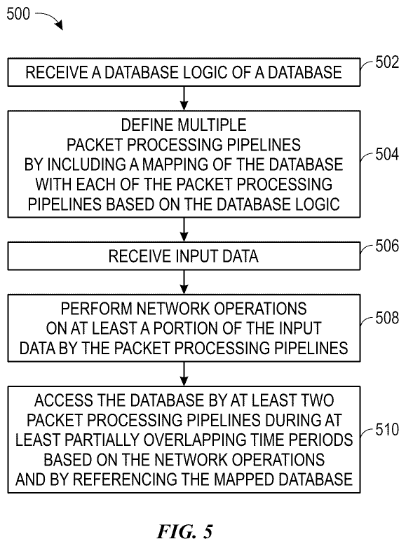

FIG. 5 is a process flow diagram illustrating a process 500 of accessing a database, such as the database 106, by multiple packet processing pipelines, such as the packet processing pipelines 114, 204, 302, and/or 424, during at least partially overlapping time periods, in accordance with an aspect of the present disclosure. The process 500 may be implemented as instructions (e.g., software instructions) carried out by the processing circuitry of a network device, such as the processing circuitry 108, 412, and/or one or more other processors and/or processing circuitry. These processors and/or processing circuitry may be disposed on either of or distributed between network switches, such as the network switches 100, 200, 300, and/or 400 and/or other devices (e.g., other network switches).

Additionally or alternatively, the processors and/or processing circuitry may be disposed on or distributed between devices that may be capable of communicating with the network switches. That is, it should be appreciated that the process 500 may be wholly executed by either of the network switches 100, 200, 300, and/or 400 or the execution may be distributed between the network switches 100, 200, 300, and/or 400 and other processing circuitry and/or network switches. Additionally, although the following process 500 describes a number of operations that may be performed, it should be noted that the process 500 may be performed in a variety of suitable orders and all of the operations may not be performed.

At block 502, a processing circuitry, such as the processing circuitry 108 receives a database logic, such as the database logic 110, 206, 306, and/or 426 of a database, such as the databases 106, 202, 304, 418, and/or 420. For example, the processing circuitry 108 may generate a request and/or retrieve the database logic 110, 206, 306, and/or 426. Alternatively or additionally, one or more of the databases 106, 202, 304, 418, and/or 420 may output the database logic 110, 206, 306, and/or 426 to a network device.

At block 504, the processing circuitry defines multiple packet processing pipelines, such as the packet processing pipelines 114, 204, 302, and/or 424, by including a mapping of one or more of the databases with each of the packet processing pipelines based on the respective database logic 110, 206, 306, and/or 426. For example, the processing circuitry 108 may define the mapped database 208 discussed above with respect to FIG. 2.

At block 506, the processing circuitry receives input data. The processing circuitry 108 may receive the input data from any viable other electronic device and/or component. At block 508, the processing circuitry 108 performs network operations on at least a portion of the input data by the packet processing pipelines 114. For example, the processing circuitry 108 may generate a number of ingress network queues 42 discussed above with respect to FIG. 3 for performing the network operations by the packet processing pipelines 114.

At block 510, the processing circuitry accesses one or more of the databases by at least two packet processing pipelines during at least partially overlapping time periods based on the network operations and by referencing the mapped database 208. For example, the packet processing pipelines 114, 204, 302, and/or 424 may use semi-lockless atomic operations with temporary spin-locks to access (e.g., insert, update, and/or delete) the data entries 118 of the database 106 and/or any data entry of one or more of the databases 202, 304, 418, and/or 420. As such, each packet processing pipeline 114, 204, 302, and/or 424 may not lock access to other data entries of the databases 106, 202, 304, 418, and/or 420 other than a target data entry (e.g., as opposed to locking access to multiple or the entirety of the target data entries) based on using a temporary spin-lock to access the target data entry. Accordingly, multiple packet processing pipelines 114, 204, 302, and/or 424 may access multiple data entries of the databases 106, 202, 304, 418, and/or 420 simultaneously, nearly simultaneously, or during at least partially overlapping time periods. Moreover, the network switches 100, 200, 300, and/or 400 may have an increased database throughput and/or have a reduced database contention rate compared to other network switches.

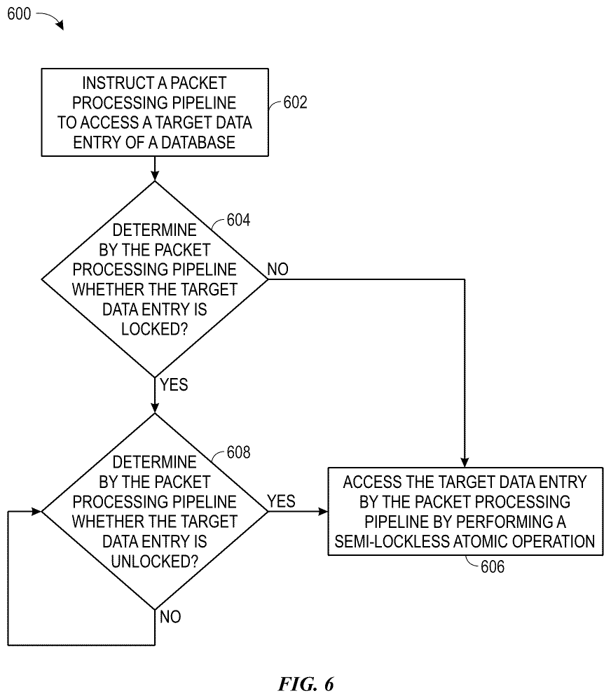

FIG. 6 is a process flow diagram illustrating a process 600 of accessing a data entry of a database, such as the target data entry 118 of the databases 106, 202, 304, 418, and/or 420, by multiple packet processing pipelines, such as the packet processing pipelines 114, 204, 302, and/or 424, using semi-lockless atomic operations with temporary spin-locks, in accordance with an aspect of the present disclosure. The process 600 may be implemented as instructions (e.g., software instructions) carried out by processing circuitry of a network switch, such as the processing circuitry 108 and/or 412, and/or one or more other processors and/or processing circuitry. These processors and/or processing circuitry may be disposed on either of or distributed between network switches, such as the network switches 100, 200, 300, and/or 400 and/or other devices (e.g., other network switches).

Additionally or alternatively, the processors and/or processing circuitry may be disposed on or distributed between devices that may be capable of communicating with the network switches. That is, it should be appreciated that the process 600 may be wholly executed by either of the network switch 100, 200, 300, and/or 400 or the execution may be distributed between the network switches 100, 200, 300, and/or 400 and other processing circuitry and/or network switches. Additionally, although the following process 600 describes a number of operations that may be performed, it should be noted that the process 600 may be performed in a variety of suitable orders and all of the operations may not be performed.

At block 602, the processing circuitry instructs a packet processing pipeline, such as one of the packet processing pipelines 114, to access a target data entry, such as the target data entry 118, of the a database, such as the databases 106, 202, 304, 418, and/or 420. For example, the processing circuitry 108 may instruct the packet processing pipeline 114, 204, 302, and/or 424 to perform network operations on at least a portion of the input data associated with an ingress network queue 42 discussed above. Moreover, the processing circuitry 108 may instruct the packet processing pipeline 114, 204, 302, and/or 424 to access the data entry 118-1 of the database 106 and/or any target data entry of the databases 202, 304, 418, and/or 420. The packet processing pipelines 114, 204, 302, and/or 424 may access the databases 106, 202, 304, 418, and/or 420 using semi-lockless atomic operations with temporary spin-locks.

At block 604, the processing circuitry determines by the packet processing pipeline whether the target data entry is locked. For example, the packet processing pipeline 114, 204, 302, and/or 424 may determine whether the target data entry 118-1 is temporarily locked using a spin-lock by another packet processing pipeline 114, 204, 302, and/or 424. The processing circuitry 108 may provide and/or maintain an indication of the temporary spin-locks of the data entries 118-1 by a coherency protocol (e.g., a cache coherency protocol). At block 606, the processing circuitry accesses the target data entry by the packet processing pipeline by performing a semi-lockless atomic operation when the target data entry 118-1 is not locked. Alternatively, the processing circuitry may proceed to operations of block 608 when the target data entry is temporarily locked.

At block 608, the processing circuitry determines by the packet processing pipeline whether the target data entry is unlocked or the temporary spin-lock is removed. For example, the packet processing pipeline 114, 204, 302, and/or 424 may wait for completion of the semi-lockless atomic operation of the other packet processing pipeline 114, 204, 302, and/or 424 in response to the target data entry 118 being locked by the temporary spin-lock. The packet processing pipeline may return to the block 608 (e.g., spin) to determine whether the temporary spin-lock of the target data entry is removed in response to the target data entry being locked. The packet processing pipeline may continuously check the lock status of the target data entry with or without a delay after each determination of the target data entry being locked.

Alternatively, the processing circuitry accesses the target data entry by the packet processing pipeline by performing a semi-lockless atomic operation when the target data entry is unlocked. Although the process 600 is described for a single packet processing pipeline and a single target data entry, it should be appreciated that the processing circuitry may perform similar operations for each ingress network queue, such as any of the ingress network queues 42 and/or each packet processing pipeline on any number of target data entries of the database. Accordingly, the network switches 100, 200, 300, and/or 400 may have an increased database throughput and/or have a reduced database contention rate compared to other network switches by performing the process 600 for multiple ingress network queues 42 and/or packet processing pipelines 114, 204, 302, and/or 424, for example, in at least partially overlapping time periods (e.g., at least partially in parallel).

One or more specific aspects of the present disclosure will be described below. In an effort to provide a concise description of these aspects, all features of an actual implementation may not be described in the specification. It should be appreciated that in the development of any such actual implementation, as in any engineering or design project, numerous implementation-specific decisions are made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various aspects of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

While certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A network switch comprising:
database comprising a plurality of data entries and a database logic; and
processing circuitry coupled to the database, wherein the processing circuitry is configured to:
receive the database logic;
incorporate the database logic with each of a plurality of packet processing pipelines; and
update a subplurality of data entries of the plurality of data entries by at least a subplurality of packet processing pipelines of the plurality of packet processing pipelines based on the database logic incorporated therewith.

2. The network switch of claim 1, wherein the database logic is indicative of a mapped instance of the plurality of data entries.

3. The network switch of claim 2, wherein each packet processing pipeline of the subplurality of packet processing pipelines is configured to access a target data entry of the subplurality of data entries by referencing a respective mapped instance of the plurality of data entries implemented therewith.

4. The network switch of claim 1, wherein each packet processing pipeline of the subplurality of packet processing pipelines is configured to update a respective data entry of the subplurality of data entries using a semi-lockless atomic operation.

5. The network switch of claim 4, wherein the processing circuitry is configured to lock each respective data entry of the subplurality of data entries being updated during each respective semi-lockless atomic operation.

6. The network switch of claim 5, wherein the processing circuitry is configured to update the incorporated database logic of each packet processing pipeline of the plurality of packet processing pipelines with an indication of each respective data entry of the subplurality of data entries being locked.

7. The network switch of claim 5, wherein the processing circuitry is configured to unlock each respective data entry of the subplurality of data entries after each respective semi-lockless atomic operation.

8. A network switch comprising:
database comprising a plurality of data entries and a database logic; and
processing circuitry coupled to the database, wherein the processing circuitry is configured to comprise a plurality of packet processing pipelines, wherein each packet processing pipeline of the plurality of packet processing pipelines is configured to comprise a mapped instance of the database based on the database logic, and is configured to update a subplurality of data entries of the plurality of data entries based on the mapped instance of the database.

9. The network switch of claim 8, wherein the processing circuitry is configured to receive the database logic, and each packet processing pipeline of the plurality of packet processing pipelines is configured to comprise the mapped instance of the database by accessing the received database logic.

10. The network switch of claim 8, wherein each packet processing pipeline of the subplurality of packet processing pipelines is configured to lock access to each data entry of the subplurality of data entries during a time period of updating the respective data entry of the subplurality of data entries.

11. The network switch of claim 10, wherein the processing circuitry is configured to provide an indication of each locked data entry of the subplurality of data entries to the mapped instances of the database of each packet processing pipeline of the plurality of packet processing pipelines.

12. The network switch of claim 8, wherein a packet processing pipeline of the subplurality of packet processing pipelines is configured to determine a data value associated with a portion of input data, and update one or more respective data entries of the subplurality of data entries based on the data value.

13. The network switch of claim 12, wherein the data value is indicative of data traffic statistics or telemetry information associated with the portion of input data.

14. The network switch of claim 12, comprising an application-specific integrated circuit (ASIC) coupled to the processing circuitry, wherein the ASIC is configured to receive the input data, and provide the portion of the input data to the packet processing pipeline.

15. The network switch of claim 8, wherein the processing circuitry is disposed with a chassis, a first portion of the database is disposed with the chassis, and a second portion of the database is disposed outside of the chassis.

16. Tangible, non-transitory, computer-readable media storing instructions that, when executed by processing circuitry of a network switch, cause the processing circuitry to:
receive database logic of a database;
generate a plurality of packet processing pipelines by including a mapped instance of a plurality of data entries of the database with each packet processing pipeline of the plurality of packet processing pipelines, wherein the mapped instance is based on the database logic;
generate a plurality of network queues, wherein each network queue of the plurality of network queues comprises a portion of input data; and
update at least one data entry of the plurality of data entries by a first packet processing pipeline of the plurality of packet processing pipelines based on the mapped instance of the database incorporated therewith and a first network queue of the plurality of network queues.

17. The tangible, non-transitory, computer-readable media of claim 16, wherein each network queue of the plurality of network queues is associated with a network operation, and wherein the network operation comprises routing, transferring, or encrypting a respective portion of the input data.

18. The tangible, non-transitory, computer-readable media of claim 16, wherein an external memory device comprises the database, wherein the external memory device is coupled to a chassis of the network switch.

19. The tangible, non-transitory, computer-readable media of claim 16, wherein the instructions cause the processing circuitry to determine a data value associated with a respective portion of the input data of the first network queue by the first packet processing pipeline.

20. The tangible, non-transitory, computer-readable media of claim 16, wherein the instructions cause the processing circuitry to perform a first network operation associated with the first network queue by the first packet processing pipeline of the plurality of packet processing pipelines.
